(19) United States
(12) Patent Application Publication
(10) Pub. No.: US 2010/0021033 A1
(43) Pub. Date: Jan. 28, 2010

(54) Method for differentiating and displaying moving and stationary heart regions of a patient in X-ray CT

(76) Inventors: Herbert Bruder, Hochstadt (DE); Rainer Raupach, Heroldsbach (DE)

Correspondence Address: HARNESS, DICKEY & PIERCE, P.L.C., P.O.BOX 8910, RESTON, VA, 20195, US

(21) Appl. No.: 12/458,760

(22) Filed: Jul. 22, 2009

(30) Foreign Application Priority Data
Jul. 23, 2008 (DE) 10 2008 034 314.5

(51) Int. Cl. G06K 9/00; H05G 1/60

(52) U.S. Cl. 382/131; 378/4

(57) ABSTRACT

A method is disclosed for differentiating and displaying moving and stationary heart regions of a patient in X-ray CT. In at least one embodiment, the method includes carrying-out circular or helical scanning of a patient in the region of his or her heart using an X-ray CT scanner including a detector with a multiplicity of detector elements, and storing at least one sinogram from a multiplicity of projection data from encircling projection directions; and reconstructing at least one tomographic display of the heart from the at least one sinogram and displaying the at least one reconstructed display of the heart. According to at least one embodiment of the invention, the projection data are Fourier transformed, filtered with respect to a predetermined frequency, inverse transformed, reconstructed, and output together with the tomographic display of the heart.

### PRIORITY STATEMENT

The present application hereby claims priority under 35 U.S.C. §119 on German patent application number DE 10 2008 034 314.5 filed Jul. 23, 2008, the entire contents of which are hereby incorporated herein by reference.

### FIELD

At least one embodiment of the invention generally relates to a method for differentiating and displaying moving and stationary heart regions of a patient in X-ray CT. More preferably, it relates to a method comprising:

carrying out circular or helical scanning of a patient in the region of his or her heart using an X-ray CT scanner comprising a detector with a multiplicity of detector elements, and storing at least one sinogram from a multiplicity of projection data from encircling projection directions;
reconstructing at least one tomographic (tomogram, 3 D) display of the heart from the at least one sinogram and displaying the at least one reconstructed display of the heart.

### BACKGROUND

Methods for displaying the myocardial vitality, in which a differentiation and a display of moving and stationary heart regions of a patient are displayed using CT examinations, are generally known, but relatively complex to carry out; in particular, it is often necessary in this case to manually intervene in the display algorithms.

### SUMMARY

In at least one embodiment of the invention is directed to a method which, as far as possible, automatically distinguishes between moving and stationary heart regions and correspondingly displays these in a differentiated fashion so that support from a CT examination, which is as meaningful as possible, is available to a diagnosing medical practitioner during the differential diagnosis of the myocardium of a patient.

The inventors have recognized that it is possible to transform the CT measurement data into a Fourier space, where frequency filtering using frequencies which are relevant for differentiating the myocardial vitality can be carried out. These are usually frequencies with a minimum frequency corresponding to the average cardiac activity. Thus, depending on the frequency band filters used, the signals of moving or stationary tissue remain. Subsequently, an inverse transform out of the Fourier space is carried out and the remaining data are reconstructed, with only the image data from regions with the motion frequencies not filtered-out remaining.

These regions of the heart defined in this fashion can subsequently be superposed on the reconstructed displays of the entire data volume so that, for example, marking or colored display of moving or stationary heart regions is possible. This leads the user to significant differential-diagnostic heart regions in a simple fashion.

In accordance with this basic idea, the inventors propose, in at least one embodiment, a method for differentiating and displaying moving and stationary heart regions of a patient in X-ray CT, which comprises the following:
carrying-out circular or helical scanning of a patient in the region of his or her heart using an X-ray CT scanner comprising a detector with a multiplicity of detector elements, and storing at least one sinogram from a multiplicity of projection data from encircling projection directions; and
reconstructing at least one tomographic (tomogram, 3D display) display of the heart from the at least one sinogram and displaying the at least one reconstructed display of the heart.

An improvement of this method, in at least one embodiment, lies in the fact that the projection data are Fourier transformed, filtered with respect to a predetermined frequency, inverse transformed, and output reconstructed together with the tomographic display of the heart.

Hence, the medical practitioner is provided with a very simple differential-diagnostic support with respect to the vitality of myocardial tissue.

It can furthermore be advantageous if at least one motion frequency of the heart of the patient is determined during the scan so that, with respect to the predetermined filter frequency, the user can use this motion frequency of the heart as a guide.

In more detail, at least one embodiment of the above-described method can be carried out in the form of the following:
the projection data of at least the detector elements which scan the heart region is Fourier transformed in the temporal domain,
the Fourier transformed projection data are filtered using at least one predetermined filter frequency correlated to the at least one motion frequency of the heart,
the filtered, Fourier transformed projection data are subject to an inverse transform,
an image reconstruction is carried out using the inverse transformed projection data, and
the heart regions shown in the image reconstruction of the inverse transformed projection data are marked in the tomographic display.

It can furthermore be advantageous for the heart regions reconstructed from the inverse transformed projection data to firstly be segmented and smoothed. This affords the possibility of generating a more compact region of the marking of moving or stationary heart regions.

With respect to filtering the data in Fourier space, on the one hand it is possible to use band-pass filters, which are also called bandwidth filters, and on the other hand it is possible to use band-stop filters, which are also called band-rejection filters. When band-pass filters are used, only certain predetermined filter frequencies or a determined band of filter frequencies is or are passed so that the inverse transformed and reconstructed data records only comprise information from regions which were moving during the scan with the respectively passed filter frequency. By contrast, filtering using a band-stop filter filters out precisely this predetermined frequency band so that motion located in this frequency band is removed from the subsequently inverse transformed and reconstructed data.

Of course, it is also possible to apply the two abovementioned methods parallel to one another and hence, if the same filter band was in each case attenuated or passed, obtain reciprocal results which can possibly be shown on the tomographic display with corresponding markings.

It can furthermore be advantageous for at least an average cycle frequency of the heart or a partial region of the heart to also be used as a predetermined filter frequency. This takes into account that partial regions of the heart can—at least briefly—be moved with a different, higher frequency than the average cycle frequency of the heart.

If the user of the method according to at least one embodiment of the invention is provided with a manually adjustable actuating element for influencing the predetermined filter frequency and/or the bandwidth thereof, the user is able to manipulate the filter frequency or bandwidth whilst at the same time observing the results, and thus optimize the result of the display. Here it is particularly advantageous for new filtering, including evaluation and display of the filtered data and possibly the marked tomographic display as well, to be effected with every change of the predetermined filter frequency and/or the bandwidth thereof.

In order to obtain a tomographic display which is as free of motion unsharpness as possible, it is furthermore advantageous for only projection data from a predetermined phase of the cardiac cycle to be used in the reconstruction of this tomographic display of the heart. This is preferably a cycle phase which corresponds to a rest phase of the heart.

An appropriate selection of the data used for reconstruction can also be effected using the inverse transformed projection data since this also reduces motion artifacts.

With respect to the Fourier transform to be carried out, in at least one embodiment the inventors propose different variants. Thus, on the one hand, it is possible to carry out the filtering and inverse transform of the projection data separately for each detector element. On the other hand, it is also possible to simultaneously transform the detector row or detector channel (=detector column), or all detector data with detector row and detector channel, into Fourier space and effect an appropriate filtering according to the above-described method in the space.

With respect to the type of tomographic display, it is possible, on the one hand, to use a tomogram or, on the other hand, to use a 3D display, in which, particularly in the case of the 3D display, a freeing from the surrounding tissue can be carried out.

Additionally, reference is made to the fact that the abovementioned method can be carried out with projection data in both conical coordinates and Cartesian coordinates. Furthermore, the above-described method is suitable for use in the field of sequential circular scans, preferably with multi-row detectors, or else for use in helical scans in which a feed is preferably used which leads to redundant data records.

A computer system for reconstructing, evaluating and displaying CT image data, comprising a memory with computer programs is also within the scope of the invention, in which computer system, when operational, at least one of the computer programs executes at least one embodiment of the above-described method according to at least one embodiment of the invention, at least in its basic outlines.

In the following text, at least one embodiment of the invention will be described in more detail with reference to the example embodiments and using the figures, with only the features required to understand at least one embodiment of the invention being illustrated. Here, the following reference symbols are used: 1: CT system; 2: first X-ray tube; 3: first detector; 4: second X-ray tube (optional); 5: second detector (optional); 6: gantry housing; 7: patient; 8: displaceable patient couch; 9: system axis; 10: control and computational unit; 11: contrast agent applicator; 12: ECG line; 13: control line for the contrast agent applicator; 14: measuring field; 15: memory; 16: heart; 17: moving region of the heart; 18: stationary region of the heart; 19: region of the heart which is not moving; 101: scan of a patient; 102: calculating the projection data; 103: Fourier transform; 104: filtering; 105: inverse Fourier transform; 106: data reconstruction of the inverse transform; 107: image display; 108: segmenting moving or stationary image portions; 109: reconstruction of the untreated projection data; 110: image display; 111: combination of image displays; 112: output of a combined image; Prg₁-Prgₙ: computer programs.

### BRIEF DESCRIPTION OF THE DRAWINGS

In detail:

FIG. 1 shows a CT system for carrying out the method according to an embodiment of the invention,

FIG. 2 shows a flowchart of an example method,

FIG. 3 shows an illustration of the method according to an embodiment of the invention using CT tomograms, and

FIG. 4 shows an illustration of the method according to an embodiment of the invention using 3D displays of the heart.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

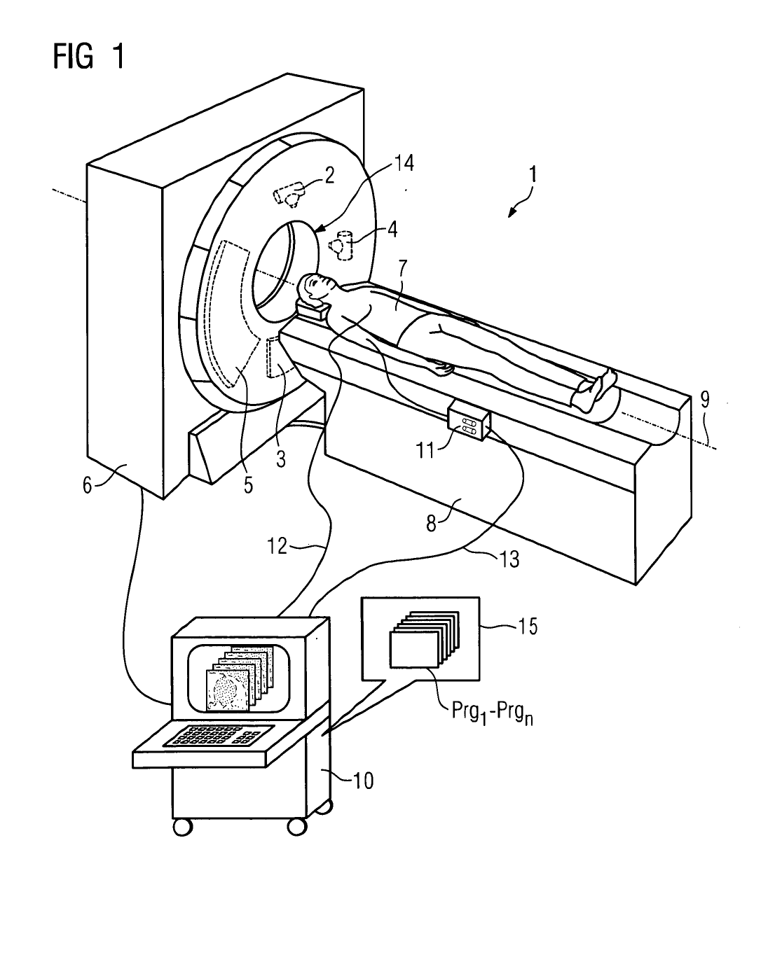

FIG. 1 shows a CT system 1 which is suitable for carrying out the method according to an embodiment of the invention. There, a first X-ray tube 2 with an opposing detector 3 which scans a measuring field 14 is located in a gantry housing 6. A patient 7, located on a displaceable patient couch 8, is continuously or sequentially pushed through the measuring field 14, while the tube/detector system 2, 3 scans the patient 7 in a rotating fashion. Optionally, it is possible for further tube/detector systems to be used for scanning. In the present example, a second X-ray tube 4 with an opposing second detector 5 is illustrated, which, in addition to the first tube/detector system, also scans the patient 7, for example to improve the resolution. Alternatively, it is possible to use the second tube/detector system to scan the patient using a different X-ray energy. Additionally, contrast agent can be applied to the patient 7 during the scan by using a contrast agent applicator 11 which is controlled by the control and computational system 10 via a control line 13 while, via an ECG line 12, the current heart frequency of the patient 7 can be recorded and can also be used to trigger a gated CT record. In the control and computational unit 10 there is a memory 15, which can for example be a random access memory or a non-transient hard disk storage unit or the like, in which computer programs Prg₁-Prgₙ are stored, with at least one of these computer programs Prg₁ to Prgₙ being able to execute the method according to the invention when operational.

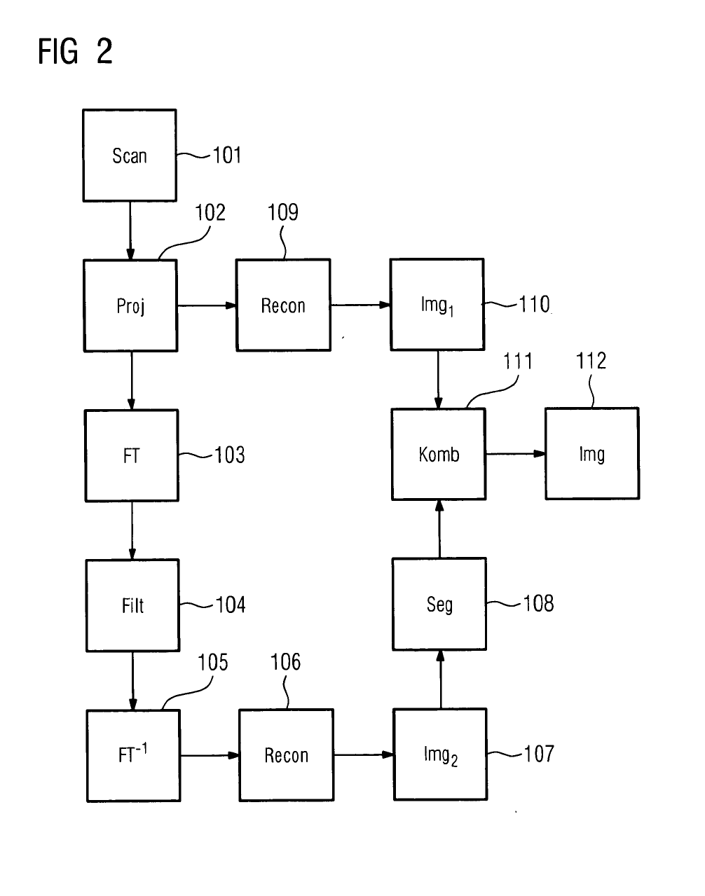

An example of a method according to an embodiment of the invention is illustrated schematically in FIG. 2 in the form of a flow chart. According to this, the method starts with method step 101 where the patient is scanned. From this, method step 102 calculates projection data which can be reconstructed in a known manner in method step 109. Here, the reconstructed image is kept ready in method step 110.

Parallel to steps 109 and 110, the projection data are subject to a Fourier transform in method step 103 and filtered by a band-pass and/or band-stop filter in method step 104, whereupon it is subsequently inverse transformed in method step 105 via an inverse Fourier transform to again form reconstructible projection data, with the filtered-out values now missing from this data. In method step 106, this filtered and inverse transformed data are reconstructed to form an image Img₂. This image Img₂ can additionally be segmented in method step 108 and hence regions with or without motion are determined. In method step 111, the regions determined in method step 108 or method step 107 are combined with the image Img₁, which was generated by the entire data record, so that moving or stationary regions are marked and this combined image Img can be output in method step 112.

According to an embodiment of the invention, the results of the above-described method can be displayed both as tomograms and in a three-dimensional tomographic view.

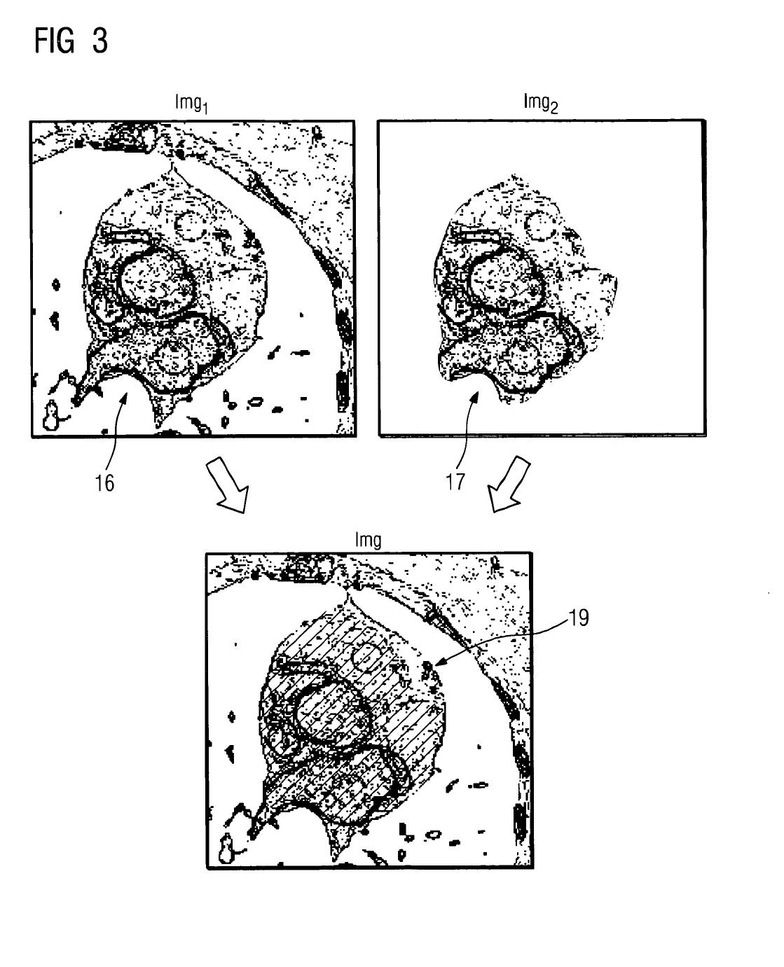

FIG. 3 shows an example of a tomogram in which the image Img₁ (top left) shows the complete reconstruction of a heart 16 in the region of the thorax. Next to it, the image Img₂ (top right) shows the reconstruction of the filtered projection data, in this case using a band-pass filter so that only the moving parts 17 of the heart can be recognized. These parts mark a region which can, for example, be marked by shading or colored highlighting in the image 1 mg lying below it after the overall reconstruction. The present example shows that this combination results in the entire heart being marked except for a partial region 19 top right, which obviously did not contain any motion information during the CT scan. Hence, it can be assumed that this region 19 has necrotic changes, or at least is hypoperfused.

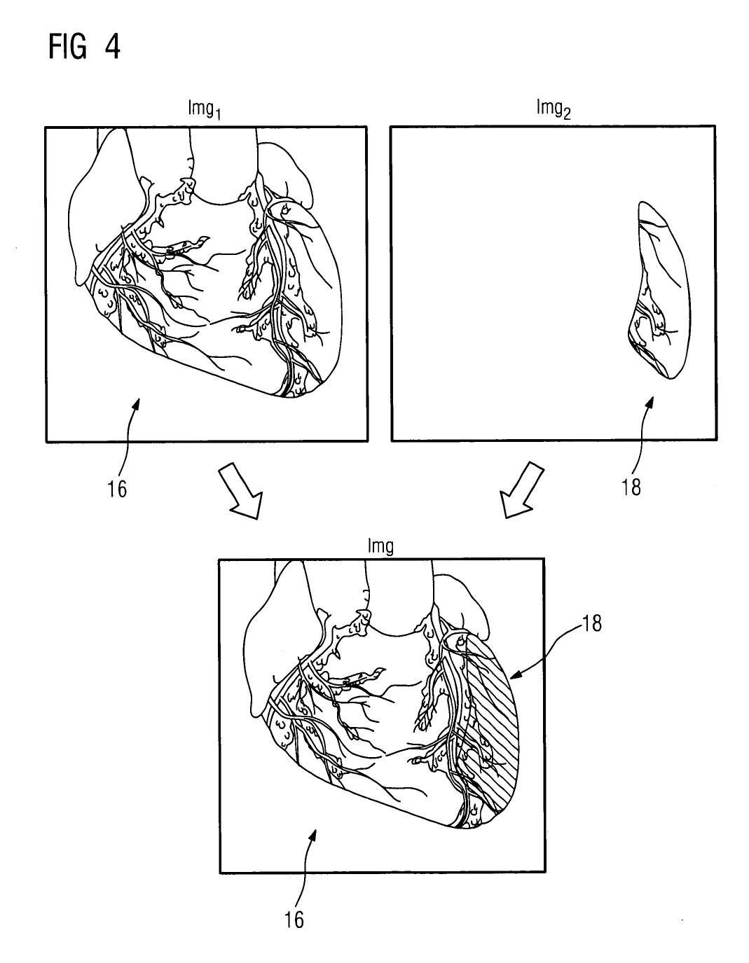

A similar display, but in 3D in this case, is shown in FIG. 4. Here, the top left shows a 3D record of a heart 16 in the image Img₁ which is generated from the entire available projection data record without filtering or from only a selection of projection data to avoid motion unsharpness. Next to it, the image Img₂ on the right shows a reconstruction of filtered, Fourier transformed and inverse transformed projection data which marks a region 18 in which there was no motion. Accordingly, the data of the image Img₂ shown here was subject to band-stop filtering which eliminates all data with a certain motion frequency.

The overall image Img illustrated below then shows the heart 16 reconstructed from a complete data record, with the region 18 of the image Img₂ being highlighted by shading in this image. According to an embodiment of the invention, this marking can also be replaced by a colored marking or something similar.

In conclusion, it can be seen that the method according to an embodiment of the invention provides the user with flexible means for detecting regions of a beating heart with good movability or which are stationary and thus is able to direct the diagnostic attention to the respectively desired regions.

It goes without saying that the abovementioned features of an embodiment of the invention can be used not only in the respectively specified combination, but also in other combinations or on their own without departing from the scope of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for differentiating and displaying moving and stationary heart regions of a patient in X-ray CT, the method comprising:
carrying out circular or helical scanning of a patient in a region of a heart of the patient using an X-ray CT scanner including a detector with a multiplicity of detector elements;
storing at least one sinogram obtained from a multiplicity of projection data from scans of encircling projection directions;
reconstructing at least one tomographic display of the heart of the patient from the at least one stored sonogram; and
displaying the at least one reconstructed tomographic display of the heart of the patient, wherein the projection data are Fourier transformed, filtered with respect to a frequency, inverse transformed, reconstructed, and output together with the tomographic display of the heart of the patient.

2. The method as claimed in claim 1, wherein at least one motion frequency of the heart of the patient is determined during the scan.

3. The method as claimed in claim 2, wherein:
the projection data of at least the detector elements which scan the heart region is Fourier transformed in the temporal domain,
the Fourier transformed projection data are filtered using at least one filter frequency correlated to the at least one motion frequency of the heart,
the filtered, Fourier transformed projection data are subject to an inverse transform,
an image reconstruction is carried out using the inverse transformed projection data, and
the heart regions shown in the image reconstruction of the inverse transformed projection data are marked in the tomographic display.

4. The method as claimed in claim 3, wherein the heart regions reconstructed from the inverse transformed projection data are at least one of segmented and smoothed.

5. The method as claimed in claim 1, wherein the filtering is effected by a band-pass filter which only passes a filter band around the at least one filter frequency.

6. The method as claimed in claim 1, wherein the filtering is effected by a band-stop filter which only attenuates a filter band around the at least one filter frequency.

7. The method as claimed in claim 1, wherein, firstly, the filtering is effected by a band-stop filter which only attenuates a filter band around the predetermined at least one filter frequency, and, secondly, the filtering is effected by a band-pass filter which only passes a filter band around the at least one filter frequency, the results of both filtering processes being handled separately and thus different marking are generated on the tomographic display.

8. The method as claimed in claim 1, wherein at least an average cycle frequency of the heart is also used as a filter frequency.

9. The method as claimed in claim 1, wherein at least a motion frequency of a partial region of the heart is also used as a filter frequency.

10. The method as claimed in claim 1, wherein a user is provided with a manually adjustable actuating element for influencing at least one of the filter frequency and the bandwidth thereof.

11. The method as claimed in claim 10, wherein new filtering, including evaluation and display of the filtered data is effected with every change of the at least one of the filter frequency and the bandwidth thereof.

12. The method as claimed in claim 1, wherein only projection data from a phase of the cardiac cycle is used in the reconstruction of the tomographic display of the heart.

13. The method as claimed in claim 1, wherein only inverse transformed projection data from a phase of the cardiac cycle is used in the reconstruction with the inverse transformed projection data.

14. The method as claimed in claim 1, wherein the Fourier transform, filtering and the inverse transform of the projection data are effected separately for each detector element.

15. The method as claimed in claim 1, wherein the Fourier transform, filtering and the inverse transform of the projection data are effected separately for each detector row.

16. The method as claimed in claim 1, wherein the Fourier transform, filtering and the inverse transform of the projection data are effected separately for each detector channel.

17. The method as claimed in claim 1, wherein the Fourier transform, filtering and the inverse transform of the projection data are, overall, effected two-dimensionally with respect to the detector row and detector channel.

18. The method as claimed in claim 1, wherein at least one tomogram is also selected as tomographic display.

19. The method as claimed in claim 1, wherein at least one 3D display is also selected as tomographic display.

20. A computer system for reconstructing, evaluating and displaying CT image data, comprising:
a memory including computer programs wherein, when operational, at least one of the computer programs executes the method in accordance with claim 1.

21. A computer readable medium including program segments for, when executed on a computer device, causing the computer device to implement the method of claim 1.

22. A system for differentiating and displaying moving and stationary heart regions of a patient in X-ray CT, the system comprising:
an X-ray CT scanner, including a detector with a multiplicity of detector elements, to carry out circular or helical scanning of a patient in a region of a heart of the patient;
a memory to store at least one sinogram obtained from a multiplicity of projection data from scans of encircling projection directions;
means for reconstructing at least one tomographic display of the heart of the patient from the at least one stored sonogram; and
a display to display the at least one reconstructed tomographic display of the heart of the patient, wherein the projection data are Fourier transformed, filtered with respect to a frequency, inverse transformed, reconstructed, and output together with the tomographic display of the heart of the patient.
